(19) United States
(12) Patent Application Publication
(10) Pub. No.: US 2026/0346225 A1
(43) Pub. Date: Nov. 5, 2026

(54) SELECTIVE SCAVENGER, PREPARATION METHOD THEREFOR AND USE

(71) Applicant: PETROCHINA COMPANY LIMITED, Beijing (CN)

(72) Inventors: Xiaoqin YAN, Chengdu, Sichuan (CN); Gang XIONG, Chengdu, Sichuan (CN); Rui FAN, Chengdu, Sichuan (CN); Mingou WU, Chengdu, Sichuan (CN); Zicheng PENG, Chengdu, Sichuan (CN); Qingmei CHEN, Chengdu, Sichuan (CN); Jinjin LI, Chengdu, Sichuan (CN)

(73) Assignee: PETROCHINA COMPANY LIMITED, Beijing (CN)

(21) Appl. No.: 19/109,197

(22) PCT Filed: Sep. 26, 2023
(86) PCT No.: PCT/CN2023/121673

§ 371 Date: Mar. 6, 2025

(30) Foreign Application Priority Data
Sep. 26, 2022 (CN) 202211173573.5

(51) Int. Cl. B01J 20/04; B01J 20/14; B01J 20/30; C02F 1/28; C02F 101/10

(52) U.S. Cl. CPC B01J 20/041; B01J 20/14; B01J 20/3007; B01J 20/3028; B01J 20/3071; B01J 20/3085; C02F 1/288; C02F 1/281; C02F 2101/105

(57) ABSTRACT

A selective scavenger, a preparation method therefor and the use. The selective scavenger contains a calcium-scandium bimetallic layered hydroxide and diatomite, the mass ratio of the diatomite to the calcium-scandium bimetallic layered hydroxide being ≥0.14, the chemical formula of the calcium-scandium bimetallic layered hydroxide being [CaₓSc(OH)_{y}]OH, x being 2-3 and y being 6-8. The selective scavenger has good selectivity with respect to thermally-stable salts and hydrogen phosphate radicals, and has a selective adsorption ratio of the hydrogen phosphate radicals to thermally-stable salt anions being >6000, thus achieving efficient separation of the thermally-stable salts and the hydrogen phosphate radicals, and has good stability, and can prolong the working period, being suitable for popularization in industry.

### CROSS-REFERENCE TO RELATED APPLICATIONS

The present application is the U.S. national stage entry of International Application No. PCT/CN2023/121673 filed Sep. 26, 2023, which claims the benefit of the Chinese patent application No. “202211173573.5”, filed on Sep. 26, 2022, entitled “SELECTIVE REMOVAL AGENT AS WELL AS PREPARATION METHOD AND APPLICATION THEREOF”, the contents of which are specifically and entirely incorporated herein by reference.

### FIELD

The present disclosure relates to the technical field of adsorptive separation, in particular to a selective scavenger, a preparation method therefor and use thereof.

### BACKGROUND

The environmental protection laws and regulations in China are increasingly stringent in recent years, the content of SO₂ in the discharged tail gas is limited to be lower and lower, thus it is more difficult for the removal depth of organic sulfur (e.g., H₂S, SO₂ and COS) by the conventional alkanolamine solvent to meet the requirement of the emission standard on the tail gas (burned flue gas).

The formula-type solvents are a series of novel desulfurization and decarburization solvents developed on the basis of N-methyl diethanolamine (MDEA) aqueous solution, and aim to enhance the removal depth of organic sulfur (e.g., H₂S, SO₂ and COS). By adding amine hydrogen phosphate into the MDEA aqueous solution, the pH value of the solvent is suitably reduced, the competitive absorption effect of CO₂ on H₂S can be alleviated, the purification degree of H₂S is improved, thereby obtaining the enhanced H₂S selective absorption formula-type alkanolamine solution.

Like the conventional alkanolamine solution, the enhanced H₂S selective absorption formula-type alkanolamine solution can be easily polluted by residues of upstream gas mining operation in the gas purifying process, a plurality of highly corrosive inorganic heat stable salts may be continuously accumulated in the solution, which is prone to cause safety problems such as corrosion and perforation of the device. When the content of inorganic heat stable salts (especially sodium chloride, calcium chloride) reaches 2% or more, it may lead to the production quality problem that the content of H₂S in the product gas exceeds the standard; when the content of sodium chloride and calcium chloride reaches 3% or more, the device is difficult to operate because of the blockage appears in the device.

When the existing reactivation technology is adopted to remove the heat stable salts in the enhanced H₂S selective absorption formula-type alkanolamine solution, the technology will also remove the hydrogen phosphate ions, so that the H₂S selective adsorption performance of the enhanced H₂S selective absorption formula-type alkanolamine solution after reactivation is degraded, and the content of H₂S in the product gas seriously exceeds the standard.

Therefore, the purification plants, oil refineries and chemical plants adopt the enhanced H₂S selective absorption formula-type alkanolamine solution to solve the production problem caused by the deterioration of the solution by using a method of refreshing the solution at present, and the replaced deteriorated alkanolamine solution can only be treated as waste liquid. However, as the content of alkanolamine and other organic matters in the deteriorated alkanolamine solution is 40% or more, and the deteriorated alkanolamine solution also contains toxic hydrogen sulfide, the deteriorated alkanolamine solution belongs to hazardous waste, the treatment of said waste liquid suffers from many difficulties and high costs, thereby bringing forth great economic loss and environmental protection pressure to the production plants.

In order to address the problem that the heat stable salts and the hydrogen phosphate ions are removed simultaneously, the hydrogen phosphate ions can be initially separated from the deteriorated alkanolamine solution by using a phosphate radical or hydrogen phosphate radical selective adsorbent, the heat stable salts in the amine liquid are then removed by using a conventional method, and finally the hydrogen phosphate ions on the adsorbent are re-eluted and recycled to the amine liquid from which the heat stable salts have been removed, so that the purpose of removing the heat stable salts without losing the hydrogen phosphate ions is achieved.

At present, the researches and inventions about the selective absorption of phosphate radials or hydrogen phosphate radials in the solution are focused on the research of dephosphorization of wastewater which is carried out to solve the problem concerning how to suppress eutrophication of water body. Different from the situation that the content of hydrogen phosphate ions in the enhanced H₂S selective absorption formula-type alkanolamine solution is high and strong competitive absorption ions exist in the solution, the water body involved with the researches and inventions is characterized in that the content of phosphate ions or hydrogen phosphate ions is low, and there are no strong competitive adsorption ions such as oxalate and thiosulfate in the water. The relevant inventions are as follows:

CN101691250A discloses a selective adsorbent and an adsorption method for chloride, nitrate, sulfate and hydrogen phosphate ions. The adsorbent provided by the invention does not substantively remove chloride ions and nitrate ions, can adsorb a small amount of sulfate ions, but has poor selective adsorption capacity on oxalate and thiosulfate ions which have strong adsorptive power. Because the purpose of removing the hydrogen phosphate ions in the enhanced H₂S selective absorption formula-type alkanolamine solution is to separate the hydrogen phosphate ions from anions of the heat stable salts, after the anions of the heat stable salts are removed by a conventional method, phosphate ions adsorbed on a scavenger need to be eluted and recycled to the amine liquid, thus the scavenger is required to adsorb only the hydrogen phosphate ions or phosphate ions without adsorbing other anions.

CN101691250A is used for the enhanced H₂S selective absorption formula-type alkanolamine solution, the co-absorption rate of oxalate and thiosulfate ions is high, sulfate ions are also adsorbed to a certain extent, but the selectivity does not meet the requirement.

The desorbing agent provided by CN101691250A has a lower adsorption capacity of 20 mg/g, it is suitable for the selectivity adsorption of medium to low concentration of anions, but the enhanced H₂S selective absorption formula-type alkanolamine solution has a high concentration of hydrogen phosphate ions and heat stable salts anions, it requires that the adsorption capacity of the adsorbing agent or the scavenger is more than 100 mg/g. Therefore, the scavenger provided by the invention does not meet the selectivity requirement and capacity requirement for the adsorption of hydrogen phosphate ions in the enhanced H₂S selective absorption formula-type alkanolamine solution.

CN110575811A discloses a process of using the prepared zirconium modified kaolin adsorbent for selectively adsorbing phosphate ions in phosphorus-rich nutritive water body. The results show that the zirconium-modified kaolin adsorbent has 63.39% removal rate of phosphate, 1.3% removal rate of sulfate, and 1.82% removal rate of chloride in a mixed solution consisting of the equal concentration of sulfate, chloride, and phosphate ions. The maximum adsorption capacity of the adsorbent for phosphate ions is 12.43 mg/g.

CN110394150A discloses a method of using the lanthanum modified mesoporous silica aerogel for selectively adsorbing phosphate ions. When chloride ions, nitrate ions, fluoride ions, sulfate ions and phosphate ions coexist, the provided adsorbent can selectively adsorb phosphate ions, and the maximum adsorption capacity is 42.08 mg/g.

In summary, none of the inventions in the prior art with respect to the selective adsorption of phosphate ions or hydrogen phosphate ions can satisfy the selectivity requirement and capacity requirement for the adsorption of hydrogen phosphate ions in the enhanced H₂S selective absorption formula-type alkanolamine solution. Therefore, it is urgent to provide a selective scavenger with desirable selectivity for hydrogen phosphate ions and heat stable salts.

### SUMMARY

The present disclosure aims to solve the problem in the prior art that the heat stable salts and the hydrogen phosphate ions are simultaneously removed in the reactivation process of the H₂S selective absorption formula-type alkanolamine solution which is deteriorated, and provides a selective scavenger (a selective scavenger can also be called selective adsorbent), a preparation method therefor and use thereof.

The first aspect of the present disclosure provides a selective scavenger comprising a calcium-scandium bimetallic layered hydroxide and diatomite, wherein the mass ratio of the diatomite to the calcium-scandium bimetallic layered hydroxide is larger than or equal to 0.14, the chemical formula of the calcium-scandium bimetallic layered hydroxide is [CaₓSc(OH)_{y}]OH, x is within the range of 2-3, and y is within the range of 6-8.

The second aspect of the present disclosure provides a method for preparing the selective scavenger comprising the following steps:
(1) mixing a first alkali liquor with an active liquid, and then carrying out the reaction to obtain a precipitate; wherein the active liquid comprises a soluble calcium-containing compound and a soluble scandium-containing compound;
(2) contacting the precipitate with a second alkali liquor for performing a modification process to obtain a calcium-scandium bimetallic layered hydroxide;
(3) blending the calcium-scandium bimetallic layered hydroxide with a diatomite and water, and then molding and granulating to prepare the selective scavenger.

The third aspect of the present disclosure provides a use of the selective scavenger according to the first aspect of the present disclosure or the selective scavenger produced with the method according to the second aspect of the present disclosure in dephosphorization, preferably the use in dephosphorization of a deteriorated alkanolamine solution.

Due to the technical scheme, the present disclosure produces the favorable technical effects as follows:
1) the selective scavenger provided by the present disclosure has good selectivity with respect to heat stable salts and hydrogen phosphate ions, and has a selective adsorption ratio of the hydrogen phosphate ions to heat stable salt anions being larger than 6,000, thus achieving efficient separation of the heat stable salts and the hydrogen phosphate ions;
2) the selective scavenger provided by the present disclosure has an excellent adsorption capacity of 100 mg/g or more for the hydrogen phosphate ions, and the desirable removal effect on the hydrogen phosphate ions;
3) the preparation method of selective scavenger provided by the present disclosure has the advantages of simple process, high selectivity, adsorption capacity and stability of the product, it is suitable for the popularization in industry.

### BRIEF DESCRIPTION OF THE DRAWINGS

FIG. 1 illustrates an X-ray diffraction spectrogram of calcium-scandium bimetallic layered hydroxide prepared in Preparation Example 1 of the present disclosure;

FIG. 2 illustrates an X-ray diffraction spectrogram of calcium-scandium bimetallic compound comparative sample prepared in Comparative Preparation Example 1 of the present disclosure;

FIG. 3 shows an infrared spectrogram of the calcium-scandium bimetallic layered hydroxide prepared in Preparation Example 1 of the present disclosure;

FIG. 4 is a concrete image of the selective adsorbent prepared in Example 1 of the present disclosure.

### DETAILED DESCRIPTION

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed have been specifically disclosed herein.

The first aspect of the present disclosure provides a selective scavenger comprising a calcium-scandium bimetallic layered hydroxide and diatomite, wherein the mass ratio of the diatomite to the calcium-scandium bimetallic layered hydroxide is larger than or equal to 0.14, the chemical formula of the calcium-scandium bimetallic layered hydroxide is [CaₓSc(OH)_{y}]OH, x is within the range of 2-3, and y is within the range of 6-8.

The heat stable salts in a deteriorated alkanolamine solution generally comprise sulfates, oxalates, thiosulfates, chlorides, formates, acetates, and glycolates. The interlaminar anions OH⁻ between the calcium-scandium bimetallic layered hydroxide can exchange with other anions in the deteriorated alkanolamine solution. Wherein the charge is higher and the radius of said anions is smaller, the exchange capacity with OH⁻ is stronger. Therefore, the exchange capacity of hydrogen phosphate ions is smaller than the oxalate ions, which has a smaller exchange capacity than the thiosulfate ions, which has a smaller exchange capacity than phosphate ions.

However, because the bimetallic layered hydroxide [Ca₍₂₋₃₎Sc(OH)₍₆₋₈₎]OH provided by the present disclosure has strong basicity and calcium hydroxide is slightly soluble, a thin layer with strong basicity can be formed at the contact interface between [Ca₍₂₋₃₎Sc(OH)₍₆₋₈₎]OH and deteriorated alkanolamine solution, thus the hydrogen phosphate ions can be converted into phosphate ions under the condition of strong basicity, the phosphate ions have a priority over oxalate ions and thiosulfate ions to exchange with OH⁻. In addition, the electrostatic interaction between the phosphate ions and scandium ions on the [Ca₍₂₋₃₎Sc(OH)₍₆₋₈₎]OH laminate is greater than that of oxalate, thiosulfate, sulfate, chloride, formate, acetate, and glycolate radical ions.

Based on the two factors mentioned above, the hydrogen phosphate ions in the deteriorated alkanolamine solution can firstly pass through the contact interface between [Ca₍₂₋₃₎Sc(OH)₍₆₋₈₎]OH and the deteriorated alkanolamine solution, are converted into phosphate ions at the contact interface and then enter the interlayer of the bimetallic layered hydroxide [Ca₍₂₋₃₎Sc(OH)₍₆₋₈₎]OH to occupy the adsorption sites. The phosphate ions and calcium ions form calcium phosphate at the adsorption sites to deposit on the inner surface, promoting the phosphate ions to enter the interlayer more quickly and increasing the adsorption capacity. Therefore, when hydrogen phosphate ions coexist with heat stable salts, the bimetallic layered hydroxide [Ca₍₂₋₃₎Sc(OH)₍₆₋₈₎]OH provided by the present invention can selectively adsorb hydrogen phosphate ions, and can realize the efficient separation of the heat stable salts and the hydrogen phosphate ions.

Because calcium hydroxide is slightly soluble, the calcium ions of calcium-scandium bimetallic layered hydroxide will lost when the calcium-scandium bimetallic layered hydroxide is contacted with deteriorated alkanolamine solution, such that the crystals are damaged. The calcium-scandium bimetallic layered hydroxide and the diatomite are mixed and granulated, so that the electronegativity of the surfaces of selective scavenger particles can be increased; By locking calcium ions on the surfaces of the selective scavenger particles, the problems with respect to the loss of calcium ions and the damage of crystals are solved, and the thin layer with a strong basicity can be kept.

In a preferred embodiment, the mass ratio of the diatomite to the calcium-scandium bimetallic layered hydroxide is within the range of 0.14-1, more preferably within the range of 0.14-0.5.

In the present disclosure, when the mass ratio of the diatomite to the calcium-scandium bimetallic layered hydroxide is more than or equal to 0.14, the selective scavenger has high adsorption selectivity and adsorption capacity, good stability and desirable industrial application prospect. Along with an increase of the content of diatomite, the adsorption selectivity, the adsorption capacity and the stability of the selective scavenger gradually increase; when the mass ratio of the diatomite to the calcium-scandium bimetallic layered hydroxide is more than or equal to 1, the adsorption selectivity, the adsorption capacity and the stability of the selective scavenger are decreased to some extent, but it can still meet the requirements of industrial use.

The overall performance of the selective scavenger is optimal when the mass ratio of the diatomite to the calcium-scandium bimetallic layered hydroxide is within the range of 0.14-0.5.

In a preferred embodiment, the chemical formula of the calcium-scandium bimetallic layered hydroxide is [Ca₂Sc(OH)₆]OH or [Ca₃Sc(OH)₈]OH.

In a preferred embodiment, the adsorption capacity of the selective adsorbent for hydrogen phosphate ions is more than or equal to 100 mg/g, preferably within the range of 120-150 mg/g.

In a preferred embodiment, the selective adsorbent has a selective adsorption ratio of the hydrogen phosphate ions to heat stable salts anions being larger than 6,000, more preferably within the range of 8,000-20,000, further preferably within the range of 10,000-17,000.

In a preferred embodiment, the adsorption performance of the selective adsorbent remains substantially unchanged after operation for 10-50 days.

The second aspect of the present disclosure provides a method for preparing the selective scavenger comprising the following steps:
(1) mixing a first alkali liquor with an active liquid, and then carrying out the reaction to obtain a precipitate; wherein the active liquid comprises a soluble calcium-containing compound and a soluble scandium-containing compound;
(2) contacting the precipitate with a second alkali liquor for performing a modification process to obtain a calcium-scandium bimetallic layered hydroxide;
(3) blending the calcium-scandium bimetallic layered hydroxide with a diatomite and water, and then molding and granulating to prepare the selective scavenger.

In the step (1),

In a preferred embodiment, an alkali in the first alkali liquor is one or more selected from the group consisting of potassium hydroxide, sodium hydroxide, and lithium hydroxide.

In a preferred embodiment, the concentration of said alkali in the first alkali liquor is within the range of 2-7 mol/L, more preferably within the range of 3-5 mol/L.

In a preferred embodiment, the soluble calcium-containing compound is one or more selected from the group consisting of calcium nitrate, calcium chloride, and calcium bromide, more preferably calcium nitrate.

In a preferred embodiment, the soluble scandium-containing compound is selected from scandium nitrate and/or scandium chloride, more preferably scandium nitrate.

In a preferred embodiment, the concentration of said soluble calcium-containing compound in the active liquid is within the range of 0.5-2.5 mol/L, more preferably within the range of 1-2 mol/L.

In a preferred embodiment, the molar ratio of the soluble calcium-containing compound to the soluble scandium-containing compound is (1-3):1, more preferably (2-3):1.

In the present disclosure, the molar ratio of the soluble calcium-containing compound to the soluble scandium-containing compound can be approximately equal to the molar ratio of calcium to scandium in the prepared calcium-scandium bimetallic layered hydroxide in the heating process.

In a preferred embodiment, the dosage ratio of the first alkali liquor to the active liquid is (100-300) mL:100 g, more preferably (125-185) mL:100 g.

In a preferred embodiment, the reaction process comprises the following steps: initially stirring the mixture obtained by mixing at 70-95 °C for 4-12 h, then heating the mixture to 80-95 °C, and standing still for 5-30 h; further preferably, the reaction process comprises the following steps: initially stirring the mixture obtained by mixing at 80-90 °C for 6-8 h, then heating the mixture to 85-95 °C, and standing still for 8-24 h.

In the present disclosure, the higher reaction temperature is beneficial to obtaining the layered hydroxide with high crystallinity and good crystal form. The growth rate of the crystals can be accelerated by subjecting the mixture to standing still at a higher temperature, and the crystal structure is more complete after subjecting the mixture to standing still for a longer time.

In a preferred embodiment, after the reaction is complete, the obtained product is subjected to filtering, washing, and drying to obtain the precipitate, wherein the washing is carried out by using water, preferably distilled water, until the pH value of the effluent water after the washing process is within the range of 7-8; the drying is performed under vacuum at a drying temperature within the range of 50-90 °C.

In the step (2),

In the present disclosure, in the precipitate obtained in the step (1), the interlaminar anions are NO₃⁻ and Cl⁻, after the precipitate is modified, and OH⁻ in the second alkali liquor can be used for replacing NO₃⁻ and Cl⁻, so as to obtain the layered hydroxide [CaₓSc(OH)_{y}]OH, wherein the interlaminar anions are OH⁻.

In a preferred embodiment, an alkali in the second alkali liquor is one or more selected from the group consisting of potassium hydroxide, sodium hydroxide, and lithium hydroxide.

In a preferred embodiment, the concentration of said alkali in the second alkali liquor is larger than or equal to 1 mol/L, more preferably within the range of 2-3 mol/L.

In a preferred embodiment, the volume ratio of the second alkali liquor to the precipitate is larger than or equal to 1, more preferably within the range of 2-8.

In a preferred embodiment, the modification process comprises: soaking the precipitate in the second alkali liquor at room temperature for 10-40 h, more preferably 20-30 h.

In the present disclosure, NO₃⁻ in the precipitate can be completely replaced by OH⁻ by controlling the alkali liquor and the soaking time to obtain the [CaₓSc(OH)_{y}]OH with a high purity. The room temperature has a well-known meaning in the art, and the room temperature is not particularly limited in the present disclosure, it may be 10-35 °C.

In a preferred embodiment, after the modification process is finished, the product obtained by the modification is initially rinsed with a washing solution and then subjected to drying to prepare the calcium-scandium bimetallic layered hydroxide.

In a preferred embodiment, the washing solution is selected from alcohol and/or water, more preferably an aqueous alcohol solution. Wherein the alcohol is selected from methanol and/or ethanol, and the concentration of said alcohol in the aqueous alcohol solution is within the range of 45-75 wt %, more preferably within the range of 50-60 wt %.

In the present disclosure, the aqueous alcohol solution is used for washing, so that the particle size of the prepared calcium-scandium bimetallic layered hydroxide is more uniform.

In the step (3),

In a preferred embodiment, the mass ratio of the diatomite and calcium-scandium bimetallic layered hydroxide is larger than or equal to 0.14 (i.e., larger than or equal to 1/7), more preferably within the range of 0.14-1, and further preferably within the range of 0.14-0.5 (i.e., 1/7-1/2).

In the present disclosure, the calcium-scandium bimetallic layered hydroxide, the diatomite and water are mixed and then molding and granulating the mixture, the surface electronegativity of the selective scavenger can be increased, calcium ions in the calcium-scandium bimetallic layered hydroxide are locked on the surface of pellets, a thin layer with a strong basicity which cannot run off is formed on the surface of said selective scavenger, thereby enhancing the selective adsorption and stability of the selective scavenger on the hydrogen phosphate ions.

In a preferred embodiment, the mass ratio of the total weight of calcium-scandium bimetallic layered hydroxide and diatomite to water is (5-8):1, preferably (6-7.5):1.

In a preferred embodiment, the molding and granulating process is performed in a ball forming mill, wherein the ball forming mill has a rotation speed within the range of 40-80 r/min, more preferably within the range of 60-70 r/min; the rotation time is within the range of 5-20 min, more preferably within the range of 8-10 min.

In the present disclosure, if the rotation time is too long, the prepared pellets have large sphere diameter, a smaller amount of the selective scavenger is filled in the stripping column with the same volume, so that the capacity of the stripping column is low; if the rotating time is too short, the sphere diameter of the prepared pellets is too small, the crushing resistance is insufficient, the selective scavenger can be easily crushed in the industrial use, its value of the industrial use is not high. The larger rotating speed is favorable for obtaining the pellets with a high crushing resistance; however, if the crushing resistance is too large and the inner part of the pellets is too dense, it is unfavorable for diffusion and exchange of anions, the present inventors have discovered that the pellets of the scavenger prepared by rotating at the rotation speed of 60-70 r/min for 8-10 min have a diameter of 2-5 mm and a crushing resistance of 120-160 N/pellet, the scavenger is most favorable for the industrial use with an optimal adsorption effect.

The third aspect of the present disclosure provides a use of the selective scavenger according to the first aspect of the present disclosure or the selective scavenger produced with the method according to the second aspect of the present disclosure in dephosphorization, preferably the use in dephosphorization of a deteriorated alkanolamine solution.

The selective scavenger provided by the present disclosure can be used for treating phosphorus-containing wastewater, especially for treating deteriorated alkanolamine solution.

When the selective scavenger is used for treating deteriorated alkanolamine solution, compared with the existing phosphorus adsorbent, the selective activator provided by the present disclosure has good selectivity with respect to heat stable salts and hydrogen phosphate ions, and has a selective adsorption ratio of the hydrogen phosphate ions to heat stable salt anions being larger than 6,000, the efficient separation of the heat stable salts and the hydrogen phosphate ions can be achieved.

The present disclosure will be described in detail below with reference to examples.

### Preparation Example 1 of Calcium-Scandium Bimetallic Layered Hydroxide

(1) calcium nitrate and scandium nitrate were added into distilled water to obtain 217.9 g of an active liquid, wherein the molar concentration of the calcium nitrate was 1.234 mol/L, and the molar concentration of the scandium nitrate was 0.617 mol/L; all the active liquid was transferred into a stainless steel kettle equipped with a polytetrafluoroethylene lining, 283 mL of an aqueous sodium hydroxide solution with a concentration of 4 mol/L was then added, a stirrer was switched on, the stainless steel kettle was heated to 80 °C for carrying out the reaction for 8 hours, subsequently further heated to 85 °C, subjected to standing still at 85 °C for 24 hours, then cooled to room temperature, filtered, and washed with distilled water until the pH of effluent water was 7-8, the filtrate was put into a vacuum drying oven for drying at 70 °C to obtain a precipitate;
(2) the dried precipitate was soaked in an aqueous sodium hydroxide solution with a concentration of 3.0 mol/L and 5 times the volume of the precipitate for 20 hours, the alkaline liquor was then washed by using an aqueous ethanol solution having a concentration of 50 wt %, and subjected to drying at 70 °C to obtain a calcium-scandium bimetallic layered hydroxide sample 1.

### Preparation Example 2 of Calcium-Scandium Bimetallic Layered Hydroxide

(1) calcium nitrate and scandium nitrate were added into distilled water to obtain 218.6 g of an active liquid, wherein the molar concentration of the calcium nitrate was 1.665 mol/L, and the molar concentration of the scandium nitrate was 0.555 mol/L; all the active liquid was transferred into a stainless steel kettle equipped with a polytetrafluoroethylene lining, 393 mL of an aqueous sodium hydroxide solution with a concentration of 4 mol/L was then added, a stirrer was switched on, the stainless steel kettle was heated to 90 °C for carrying out the reaction for 6 hours, subsequently further heated to 95 °C, subjected to standing still at 95 °C for 8 hours, then cooled to room temperature, filtered, and washed with distilled water until the pH of effluent water was 7-8, the filtrate was put into a vacuum drying oven for drying at 80 °C to obtain a precipitate;
(2) the dried precipitate was soaked in an aqueous sodium hydroxide solution with a concentration of 2.5 mol/L and 6 times the volume of the precipitate for 24 hours, the alkaline liquor was then washed by using an aqueous ethanol solution having a concentration of 60 wt %, and subjected to drying at 80 °C to obtain a calcium-scandium bimetallic layered hydroxide sample 2.

### Comparative Preparation Example 1

(1) calcium nitrate and scandium nitrate were added into distilled water to obtain 190.2 g of an active liquid, wherein the molar concentration of the calcium nitrate was 0.278 mol/L, and the molar concentration of the scandium nitrate was 0.555 mol/L; all the active liquid was transferred into a stainless steel kettle equipped with a polytetrafluoroethylene lining, 393 mL of an aqueous sodium hydroxide solution with a concentration of 4 mol/L was then added, a stirrer was switched on, the stainless steel kettle was heated to 90 °C for carrying out the reaction for 6 hours, subsequently further heated to 95 °C, subjected to standing still at 95 °C for 8 hours, then cooled to room temperature, filtered, and washed with distilled water until the pH of effluent water was 7-8, the filtrate was put into a vacuum drying oven for drying at 80 °C to obtain a precipitate;
(2) the dried precipitate was soaked in an aqueous sodium hydroxide solution with a concentration of 2.5 mol/L and 6 times the volume of the precipitate for 24 hours, the alkaline liquor was then washed by using an aqueous ethanol solution having a concentration of 60 wt %, and subjected to drying at 80 °C to obtain a calcium-scandium bimetallic compound comparative sample 1.

### Comparative Preparation Example 2

(1) calcium nitrate and scandium nitrate were added into distilled water to obtain 218.6 g of an active liquid, wherein the molar concentration of the calcium nitrate was 2.220 mol/L, and the molar concentration of the scandium nitrate was 0.555 mol/L; all the active liquid was transferred into a stainless steel kettle equipped with a polytetrafluoroethylene lining, 393 mL of an aqueous sodium hydroxide solution with a concentration of 4 mol/L was then added, a stirrer was switched on, the stainless steel kettle was heated to 90 °C for carrying out the reaction for 6 hours, subsequently further heated to 95 °C, subjected to standing still at 95 °C for 8 hours, then cooled to room temperature, filtered, and washed with distilled water until the pH of effluent water was 7-8, the filtrate was put into a vacuum drying oven for drying at 80 °C to obtain a precipitate;
(2) the dried precipitate was soaked in an aqueous sodium hydroxide solution with a concentration of 2.5 mol/L and 6 times the volume of the precipitate for 24 hours, the alkaline liquor was then washed by using an aqueous ethanol solution having a concentration of 60 wt %, and subjected to drying at 80 °C to obtain a calcium-scandium bimetallic compound comparative sample 2.

### Test Example 1

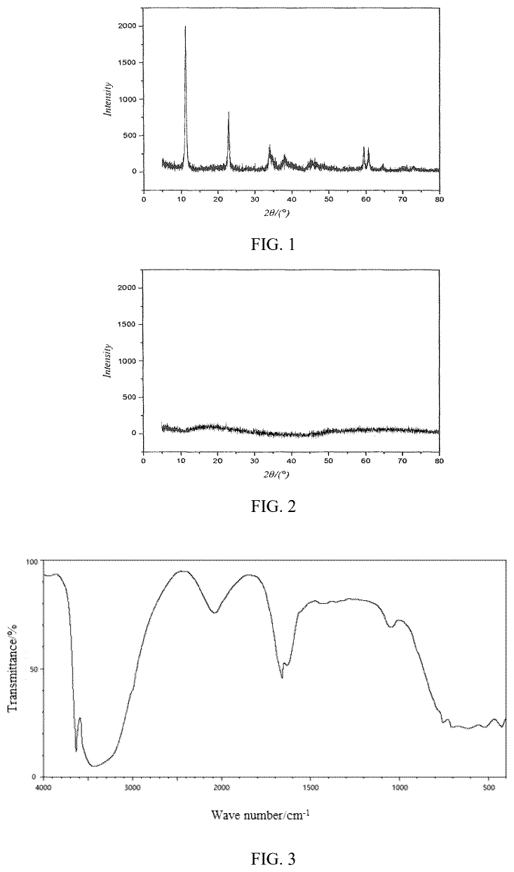

The calcium-scandium bimetallic layered hydroxide sample 1 prepared in Example 1 was subjected to the XRD characterization, and the results were shown in FIG. 1.

As illustrated by FIG. 1, the calcium-scandium bimetallic layered hydroxide prepared in Example 1 had diffraction peaks at the angle 20 around 11°, 22°, and 34°, and a double diffraction peak at the angle 20 of 60°, it had the specific X-ray diffraction characteristic peaks for the bimetallic layered hydroxide, it demonstrated that the product prepared in step (2) of Example 1 was the bimetallic layered hydroxide with a molecular formula of [M²⁺ₓN³⁺_{y}(OH)_{z}][Aⁿ⁻]ₘ, wherein M and N represented metal elements respectively, and Aⁿ⁻ represented the exchangeable anion.

The calcium-scandium bimetallic compound comparative sample 1 prepared in Comparative Preparation Example 1 was subjected to the X-ray diffraction analysis, the results were shown in FIG. 2. Clearly, no diffraction peak was detected in FIG. 2, it indicated that when the molar ratio of the soluble calcium-containing compound to the soluble scandium-containing compound was 0.5:1, the calcium-scandium bimetallic layered hydroxide could not be obtained.

The calcium-scandium bimetallic compound comparative sample 2 prepared in Comparative Preparation Example 1 was subjected to the X-ray diffraction analysis, the results were substantially the same as those shown in FIG. 2. The diffraction peak was not detected either, it indicated that when the molar ratio of the soluble calcium-containing compound to the soluble scandium-containing compound was 4:1, the calcium-scandium bimetallic layered hydroxide could not be obtained.

### Test Example 2

The calcium-scandium bimetallic layered hydroxide sample 1 prepared in Example 1 was subjected to the infrared spectrum characterization, and the characterization results were shown in FIG. 3.

Wherein the broad absorption peak appeared near 3400 cm⁻¹ was the absorption peak of hydroxyl group, the sharp absorption peak appeared near 3650 cm⁻¹ was the absorption peak of free OH⁻, and the other anion absorption peak was not observed. Therefore, as illustrated by FIG. 3, the molecular formula of the calcium-scandium bimetallic layered hydroxide sample 1 prepared in Example 1 was [M²⁺ₓN³⁺_{y}(OH)_{z}][OH]ₘ.

The exchangeable anions OH¹⁻ in the scavenger was replaced by hydrogen phosphate ions in an aqueous sodium hydrogen phosphate solution, and by measuring the content change of the hydrogen phosphate ions before and after the aqueous solution exchange and the dosage of said scavenger, it can be determined that m=1, i.e., the molecular formula of the calcium-scandium bimetallic layered hydroxide sample 1 prepared in Example 1 was [M²⁺ₓN³⁺_{y}(OH)_{z}]OH.

### Test Example 3

The calcium-scandium bimetallic layered hydroxide sample 1 prepared in Example 1 was subjected to the electron microscopy energy spectrum characterization, as can be seen from the test results, the calcium-scandium bimetallic layered hydroxide sample 1 prepared in Example 1 contained Ca, Sc and O, and did not contain other element (hydrogen element cannot be detected by the electron microscopy energy spectrum), and the content ratio of Ca, Sc and O was Ca:Sc:O=2:1:7.

The molecular formula of the calcium-scandium bimetallic layered hydroxide sample 1 prepared in Example 1 was [Ca₂Sc(OH)₆]OH by combining the test results of XRD spectrogram, infrared characterization, and electron microscopy energy spectrum.

The same characterization was performed on the calcium-scandium bimetallic layered hydroxide sample 2 prepared in Example 2 with reference to Test Examples 1-3, and the characterization results indicated that the product prepared in Example 2 was also a bimetallic layered hydroxide and the molecular formula was [Ca₃Sc(OH)₈]OH.

### Example 1

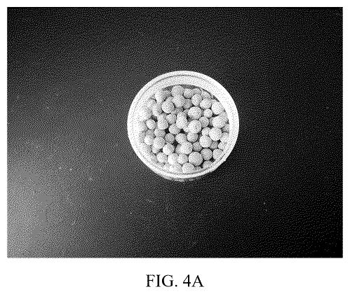

The calcium-scandium bimetallic layered hydroxide sample 1 was prepared with reference to Preparation Example 1 of the calcium-scandium bimetallic layered hydroxide, 60 g of the calcium-scandium bimetallic layered hydroxide sample 1 was mixed with 8.6 g of diatomite and 10 g of water, the mixture was rotated on a ball forming mill at a rotation speed of 65 r/min for 9 min to form pellets, a selective scavenger S1 was prepared, and a concrete image was shown in FIG. 4.

### Example 2

The calcium-scandium bimetallic layered hydroxide sample 2 was prepared with reference to Preparation Example 2 of the calcium-scandium bimetallic layered hydroxide, 60 g of the calcium-scandium bimetallic layered hydroxide sample 2 was mixed with 8.6 g of diatomite and 10 g of water, the mixture was rotated on a ball forming mill at a rotation speed of 65 r/min for 9 min to form pellets, a selective scavenger S2 was prepared.

### Comparative Example 1

The calcium-scandium bimetallic compound sample 1 was prepared with reference to the Comparative Preparation Example 1, 60 g of the calcium-scandium bimetallic compound sample 1 was mixed with 8.6 g of diatomite and 10 g of water, the mixture was rotated on a ball forming mill at a rotation speed of 65 r/min for 9 min to form pellets, a selective scavenger DS1 was prepared.

### Comparative Example 2

The calcium-scandium bimetallic compound sample 2 was prepared with reference to the Comparative Preparation Example 2, 60 g of the calcium-scandium bimetallic compound sample 2 was mixed with 8.6 g of diatomite and 10 g of water, the mixture was rotated on a ball forming mill at a rotation speed of 65 r/min for 9 min to form pellets, a selective scavenger DS2 was prepared.

### Test Example 4

Simulation of deteriorated alkanolamine solution: the heat stable salts (sodium sulfate, oxalic acid, sodium thiosulfate, sodium chloride, sodium formate, sodium acetate, and glycolic acid) and phosphoric acid were added into an aqueous methyldiethanolamine liquid with a concentration of 45 wt % to prepare the simulated deteriorated alkanolamine solution, wherein in the simulated deteriorated alkanolamine solution, the mass fraction of said heat stable salts was 6%, the mass fraction of the hydrogen phosphate ions was 3%, and the molar ratio of the sulfate ions:oxalate ion:thiosulfate ion:chloride ion:formate ion:acetate ion:glycolate ions was 1:1:1:1:1:1:1.

10 g of a strong base anion exchange resin (purchased from Jiangsu Suqing Water Treatment Engineering Group Co., Ltd., product model 201×7), 10 g of ZnAl bimetallic layered hydroxide (prepared with reference to Example 1 of CN101691250A as follows: AlCl₃·6H₂O, urea, ZnCl₂ and water were mixed to prepare a mixed solution containing 10 mM of Zn²⁺, 5 mM of Al³⁺, and 35 mM of urea, the mixed solution was heated to 100 °C and refluxed, continuously stirred for 24 hours, then precipitated and filtered, washed with deionized water and anhydrous ethanol, dried at 40 °C under the vacuum condition, and the calcined at 600 °C in an air atmosphere for 4 hours), 10 g of the selective scavenger S1 prepared in Example 1, 10 g of the selective scavenger S2 prepared in Example 2, 10 g of the selective scavenger DS1 prepared in Comparative Example 1, and 10 g of the selective scavenger DS2 prepared in Comparative Example 2 were respectively placed in 100 g of the simulated deteriorated alkanolamine solution, after subjected to oscillating for 5 hours, the solution was separated, the contents of various anions in the solution were measured, the adsorption capacity qₑ of the scavenger on each anion was calculated according to formula (1), and the test results were shown in Table 1.

$${q}_{e} = \frac{( {c}_{0} - {c}_{e} ) {w}_{1}}{1000 {w}_{2}} \qquad ( 1 )$$

qₑ—adsorption capacity, mg/g;
C₀—initial concentration of anion, the mass fraction was 10⁻⁶;
Cₑ—equilibrium concentration of anion, the mass fraction was 10⁻⁶;
w₁—solution mass, g;
w₂—mass of scavenger, g.

TABLE 1

| | Adsorption capacity qₑ/(mg/g) | | | | | |
|---|---|---|---|---|---|---|
| | Strong base | ZnAl | | | | |
| | anion | bimetallic | | | | |
| | exchange | layered | Example | Example | Comparative | Comparative |
| Items | resin | hydroxide | 1 | 2 | Example 1 | Example 2 |
| Glycolic acid | 9.424 | <0.001 | <0.001 | <0.001 | <0.001 | <0.001 |
| radical | | | | | | |
| Acetate | 10.108 | <0.001 | <0.001 | <0.001 | <0.001 | <0.001 |
| Formate radical | 10.620 | <0.001 | <0.001 | <0.001 | <0.001 | <0.001 |
| Chloride ion | 11.446 | <0.001 | <0.001 | <0.001 | <0.001 | <0.001 |
| Sulfate radical | 13.048 | 0.005 | <0.001 | <0.001 | <0.001 | <0.001 |
| Oxalate | 14.002 | 7.031 | 0.002 | 0.003 | <0.001 | <0.001 |
| Thiosulfate | 15.218 | 8.243 | 0.007 | 0.013 | <0.001 | <0.001 |
| The sum of | 83.866 | 15.279 | 0.009 | 0.015 | <0.001 | <0.001 |
| anions in the | | | | | | |
| heat stable salts | | | | | | |
| Hydrogen | 15.120 | 4.625 | 146.018 | 140.537 | <0.001 | <0.001 |
| phosphate ions | | | | | | |
| Selective | 0.2 | 0.3 | 16224 | 9369 | — | — |
| adsorption | | | | | | |
| ratio* | | | | | | |

Note
*selective adsorption ratio = adsorption capacity of the hydrogen phosphate ions ÷ adsorption capacity of the anions in the heat stable salts

As can be seen from Table 1, the samples prepare by mixing the calcium-scandium compound in the non-bimetallic layered hydroxide prepared in Comparative Examples 1-2 with diatomite do not have the ability to remove the anions in the heat stable salts and the hydrogen phosphate ions. The samples prepared by mixing the calcium-scandium bimetallic layered hydroxide prepared in Examples 1-2 with diatomate have extremely high selective adsorption performance for hydrogen phosphate ions, the selective adsorption ratio of the hydrogen phosphate ions to the heat stable salt anions is above 6,000, the adsorption capacity for hydrogen phosphate ions is larger than 100 mg/g, both the selective adsorption and adsorption capacity for hydrogen phosphate ions are significantly better than the prior art, the efficient separation of the heat stable salts and the hydrogen phosphate ions can be achieved.

### Test Example 5

The calcium-scandium bimetallic layered hydroxide sample 1 was prepared with reference to Preparation Example 1 of calcium-scandium bimetallic layered hydroxide, the selective scavenger S1 was prepared by referring to Example 1.

The calcium-scandium bimetallic layered hydroxide sample 1 and the selective scavenger S1 were loaded in two adsorption columns, respectively, the simulated deteriorated alkanolamine solution in Test Example 4 was then continuously injected into the two adsorption columns from top to bottom at a flow rate of 4 mL/min, 5 g of the sample was taken out at set intervals, the selective adsorption and adsorption capacity of the sample to hydrogen phosphate ions were tested according to the method described in Test Example 4, the test results were shown in Table 2.

TABLE 2

| | Calcium-scandium | | | | | | | |
|---|---|---|---|---|---|---|---|---|
| | bimetallic layered | | | | | | | |
| | hydroxide sample 1 | | Selective scavenger S1 | | | | | |
| | After 1 | After 2 | After 1 | After 2 | After 5 | After 10 | After 30 | After 50 |
| Items | day | days | day | days | days | days | days | days |
| Adsorption | 172.036 | <0.001 | 146.011 | 145.931 | 145.871 | 145.852 | 145.716 | 145.601 |
| capacity qₑ of | | | | | | | | |
| the hydrogen | | | | | | | | |
| phosphate | | | | | | | | |
| ions, mg/g | | | | | | | | |
| Selective | 17102 | — | 16223 | 16214 | 16208 | 16206 | 16190 | 16178 |
| adsorption | | | | | | | | |
| ratio | | | | | | | | |

As can be seen from Table 2, the initial adsorption capacity of the calcium-scandium bimetallic layered hydroxide sample 1 is 172.036 mg/g, and the adsorption capacity decreases to less than 0.001 mg/g after elution by the simulated deteriorated alkanolamine solution for 2 days, because the crystals of the calcium-scandium bimetallic layered hydroxide sample 1 are destroyed. The initial adsorption capacity of the selective scavenger S1 is 146.011 mg/g, the adsorption capacity to hydrogen phosphate ions and the selective adsorption ratio are basically kept unchanged after elution by the simulated deteriorated alkanolamine solution for 50 days.

As can be seen from comparison between the test results of the calcium-scandium bimetallic layered hydroxide sample 1 and the selective scavenger S1, although the use of the calcium-scandium bimetallic layered hydroxide reactivated deteriorated alkanolamine solution alone has a desirable initial adsorption effect, it has poor stability, and the industrial use value is very poor because the deteriorated alkanolamine solution completely fails after two days of use.

When the calcium-scandium bimetallic layered hydroxide is mixed with diatomite to prepare the spherical selective adsorbent particles, the selective adsorbent particles can keep long-term stability of performance and have high industrial use value.

### Example 3

The calcium-scandium bimetallic layered hydroxide sample 2 was prepared with reference to Preparation Example 2 of the calcium-scandium bimetallic layered hydroxide, 60 g of the calcium-scandium bimetallic layered hydroxide sample 2 was mixed with 60 g of diatomite and 10 g of water, the mixture was rotated on a ball forming mill at a rotation speed of 65 r/min for 9 min to form pellets, a selective scavenger S3 was prepared.

### Comparative Example 3

The calcium-scandium bimetallic layered hydroxide sample 2 was prepared with reference to Preparation Example 2 of the calcium-scandium bimetallic layered hydroxide, 60 g of the calcium-scandium bimetallic layered hydroxide sample 2 was mixed with 7.5 g of diatomite and 10 g of water, the mixture was rotated on a ball forming mill at a rotation speed of 65 r/min for 9 min to form pellets, a selective scavenger DS3 was prepared.

### Test Example 6

The selective scavenger S3 and the selective scavenger DS3 were subjected to the stability testing with reference to Test Example 5, the test results were shown in Table 3 as follows:

TABLE 3

| | Selective scavenger DS3 | | | Selective scavenger S3 | | | | | |
|---|---|---|---|---|---|---|---|---|---|
| | After | After 2 | After 5 | After 1 | After 2 | After 5 | After | After | After |
| Items | 1 day | days | days | day | days | days | 10 days | 30 days | 50 days |
| Adsorption | 140.511 | 99.452 | <0.001 | 83.898 | 83.896 | 83.801 | 83.742 | 83.694 | 83.597 |
| capacity qₑ | | | | | | | | | |
| of the | | | | | | | | | |
| hydrogen | | | | | | | | | |
| phosphate | | | | | | | | | |
| ions, mg/g | | | | | | | | | |
| Selective | 16804 | 16800 | — | 10487 | 10487 | 10475 | 10467 | 10461 | 10449 |
| adsorption | | | | | | | | | |
| ratio | | | | | | | | | |

As can be seen from Table 3, the adsorption capacity and selective adsorption ratio of the selective scavenger S3 can keep substantially unchanged for a long time after elution by the simulated deteriorated alkanolamine solution for a long time. However, the adsorption capacity and selective adsorption ratio are slightly low, thus in the present disclosure, the mass ratio of diatomite and calcium-scandium bimetallic layered hydroxide shall not more than 1.

The initial adsorption capacity of the selective scavenger DS3 is 140.511 mg/g, and the adsorption capacity decreases to less than 0.001 mg/g after elution by the simulated deteriorated alkanolamine solution for 5 days, it indicates when the mass ratio of the diatomite and calcium-scandium bimetallic layered hydroxide is less than 0.14, the prepared sample cannot be kept stable performance for a long time, the sample lacks an industrial use value.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

1.-36. (canceled)

37. A selective scavenger comprising a calcium-scandium bimetallic layered hydroxide and diatomite, wherein a mass ratio of the diatomite to the calcium-scandium bimetallic layered hydroxide is larger than or equal to 0.14, a chemical formula of the calcium-scandium bimetallic layered hydroxide is [CaₓSc(OH)_{y}]OH, x is within a range of 2-3, and y is within a range of 6-8.

38. The selective scavenger of claim 37, wherein the mass ratio of the diatomite to the calcium-scandium bimetallic layered hydroxide is within the range of 0.14-1.

39. The selective scavenger of claim 38, wherein the mass ratio of the diatomite to the calcium-scandium bimetallic layered hydroxide is within the range of 0.14-0.5.

40. The selective scavenger of claim 37, wherein the chemical formula of the calcium-scandium bimetallic layered hydroxide is [Ca₂Sc(OH)₆]OH or [Ca₃Sc(OH)₈]OH.

41. A method for preparing the selective scavenger according to claim 1 comprising the following steps:
(1) mixing a first alkali liquor with an active liquid, and then carrying out the reaction to obtain a precipitate; wherein the active liquid comprises a soluble calcium-containing compound and a soluble scandium-containing compound;
(2) contacting the precipitate with a second alkali liquor for performing a modification process to obtain a calcium-scandium bimetallic layered hydroxide;
(3) blending the calcium-scandium bimetallic layered hydroxide with a diatomite and water, and then molding and granulating to prepare the selective scavenger.

42. The method of claim 41, wherein an alkali in the first alkali liquor is one or more selected from the group consisting of potassium hydroxide, sodium hydroxide, and lithium hydroxide;
and/or, wherein the concentration of said alkali in the first alkali liquor is within the range of 2-7 mol/L.

43. The method of claim 41, wherein the soluble calcium-containing compound is one or more selected from the group consisting of calcium nitrate, calcium chloride, and calcium bromide;
the scandium-containing compound is selected from scandium nitrate and/or scandium chloride;
the concentration of said soluble calcium-containing compound in the active liquid is within the range of 0.5-2.5 mol/L;
the molar ratio of the soluble calcium-containing compound to the soluble scandium-containing compound is (3-1):1.

44. The method of claim 43, wherein the soluble calcium-containing compound is calcium nitrate;
the scandium-containing compound is scandium nitrate;
the concentration of said soluble calcium-containing compound in the active liquid is within the range of 1-2 mol/L;
the molar ratio of the soluble calcium-containing compound to the soluble scandium-containing compound is (2-3):1.

45. The method of claim 41, wherein the dosage ratio of the first alkali liquor to the active liquid is (100-300) mL:100 g;
and/or, wherein the reaction process comprises the following steps: initially stirring the mixture obtained by mixing at 70-95 °C for 4-12 h, then heating the mixture to 80-95 °C, and standing still for 5-30 h.

46. The method of claim 41, wherein the obtained product is sequentially subjected to filtering, washing, and drying after the reaction is completed.

47. The method of claim 41, wherein an alkali in the second alkali liquor is one or more selected from the group consisting of potassium hydroxide, sodium hydroxide, and lithium hydroxide;
and/or, wherein the concentration of said alkali in the second alkali liquor is larger than or equal to 1 mol/L;
and/or, wherein the volume ratio of the second alkali liquor to the precipitate is larger than or equal to 1.

48. The method of claim 47, wherein the concentration of said alkali in the second alkali liquor is within the range of 2-3 mol/L;
wherein the volume ratio of the second alkali liquor to the precipitate is within the range of 2-8.

49. The method of claim 41, wherein the modification process comprises: soaking the precipitate in the second alkali liquor at room temperature for 10-40 h.

50. The method of claim 41, wherein after the modification process is finished, the product obtained by the modification is initially rinsed with a washing solution and then subjected to drying to prepare the calcium-scandium bimetallic layered hydroxide;
and/or, wherein the washing solution is selected from alcohol and/or water.

51. The method of claim 41, wherein the mass ratio of the diatomite and calcium-scandium bimetallic layered hydroxide is larger than or equal to 0.14.

52. The method of claim 51, wherein the mass ratio of the diatomite to the calcium-scandium bimetallic layered hydroxide is within the range of 0.14-1.

53. The method of claim 52, wherein the mass ratio of the diatomite to the calcium-scandium bimetallic layered hydroxide is within the range of 0.14-0.5.

54. The method of claim 41, wherein the mass ratio of the total weight of calcium-scandium bimetallic layered hydroxide and diatomite to water is (5-8):1;
and/or, wherein the molding and granulating process is performed in a ball forming mill;
the ball forming mill has a rotation speed within the range of 40-80 r/min and a rotation time within the range of 5-20 min.

55. A use of the selective scavenger of claim 37.

56. The use of claim 55, wherein the use is dephosphorization of a deteriorated amine solution.
